(19) United States
(12) Patent Application Publication
(10) Pub. No.: US 2012/0287277 A1
(43) Pub. Date: Nov. 15, 2012

(54) MACHINE DISPLAY SYSTEM

(76) Inventors: Craig L. Koehrsen, East Peoria, IL (US); Aaron M. Donnelli, Metamora, IL (US); Clay D. Reitz, Morton, IL (US); Ferid Gharsalli, Peoria, IL (US); Kiran Bharwani, Dunlap, IL (US)

(21) Appl. No.: 13/107,531

(22) Filed: May 13, 2011

(51) Int. Cl. H04N 7/18

(52) U.S. Cl. 348/148; 348/E07.085

(57) ABSTRACT

A display system for a mobile machine operating at a worksite is disclosed. The display system may have at least one detection device configured to detect objects within a distance of the mobile machine, at least one camera configured to generate a plurality of camera views of the worksite around the mobile machine, a display located within the mobile machine, and a controller in communication with the at least one detection device, the at least one camera, and the display. The controller may be configured to cause an indication of proximity of objects detected by the at least one detection device to be shown on the display, and to automatically cause the camera view of the plurality of camera views associated with a closest objected detected by the at least one detection device to be shown on the display simultaneous with the indication of proximity.

### TECHNICAL FIELD

The present disclosure is directed to a display system and, more particularly, a system for displaying within a mobile machine information regarding the machine's environmental surroundings.

### BACKGROUND

Mobile machines such as haul trucks, excavators, motor graders, backhoes, water trucks, and other large equipment are utilized at a common worksite to accomplish a variety of tasks. At these worksites, because of the size of these machines, lack of visibility, slow response time, and difficulty of operation, operators should be keenly aware of their surroundings. Specifically, each operator should be aware of the location of stationary objects at the worksite, road conditions, facilities, and other mobile machines in the same vicinity. Based on the speed of a particular machine, and its size and response profile, the operator of the machine should respond differently to each encountered obstacle in order to avoid collision and damage to the machine, the objects at the worksite, and the other mobile machines. In some situations, however, there may be insufficient warning for the operator to adequately maneuver the machine away from damaging encounters.

One way to help reduce the likelihood of damaging encounters is disclosed in U.S. Patent Publication No. 2009/0259401 of Edwards et al. that published Oct. 15, 2009 (the '401 publication). Specifically, the '401 publication discloses a collision avoidance system that includes an obstacle sensor such as a motion detector, an RFID detector, a GPS tracking system, a LIDAR device, a RADAR device, or a SONAR Device; a camera; and a display such as a monitor, an LCD screen, or a plasma screen located within a cab of a machine. The display shows captured images from the motion detector of obstacles on a visual representation of a worksite (i.e., on an electronic map). The display can operate in a mixed mode, where a first portion of the display is devoted to the map with the obstacles shown on the map, a second portion is devoted to images from the camera, and a third portion is devoted to status information. By using the collision avoidance system, a machine operator may be more aware of machine surroundings and better able to avoid collision with the obstacles.

Although the collision avoidance system of the '401 publication may help a machine operator to avoid collision with an obstacle, it may be less than optimal. In particular, the display disclosed in the '401 publication may be unable to link obstacle information, camera images, and status information together to provide a comprehensive representation of a machine's environment. Without this ability, some knowledge regarding the obstacles could be lost and/or misinterpreted.

The disclosed machine display system is directed to overcoming one or more of the problems set forth above and/or other problems of the prior art.

### SUMMARY

One aspect of the present disclosure is directed to a display system for a mobile machine operating at a worksite. The display system may include at least one detection device mounted on the mobile machine and configured to detect objects within a distance of the mobile machine, at least one camera mounted on the mobile machine and configured to generate a plurality of camera views of the worksite around the mobile machine, a display located within the mobile machine, and a controller in communication with the at least one detection device, the at least one camera, and the display. The controller may be configured to cause an indication of proximity of objects detected by the at least one detection device to be shown on the display, and to automatically cause a camera view from a plurality of camera views that is associated with a closest object detected by the at least one detection device to be shown on the display simultaneous with the indication of proximity.

Another aspect of the present disclosure is directed to another display system for a mobile machine operating at a worksite. This display system may include a plurality of detection devices mounted on the mobile machine and configured to detect objects within different zones around the mobile machine, a display located within the mobile machine, and a controller in communication with the at least one detection device and the display. The controller may be configured to cause an indication of proximity of objects detected by the plurality of detection devices to be shown on the display, and cause a plurality of directional indicators to be shown on the display. Each of the plurality of directional indicators corresponds with a different zone in which an object is detected, and the directional indicator of the plurality of directional indicators corresponding with the zone having the detected object located closest to the mobile machine is shown differently on the display than the remainder of the plurality of directional indicators.

### BRIEF DESCRIPTION OF THE DRAWINGS

FIG. 1 is a diagrammatic illustration of an exemplary disclosed machine; and

FIGS. 2 and 3 are pictorial illustrations of an exemplary disclosed display system that may be used in conjunction with the machine of FIG. 1.

### DETAILED DESCRIPTION

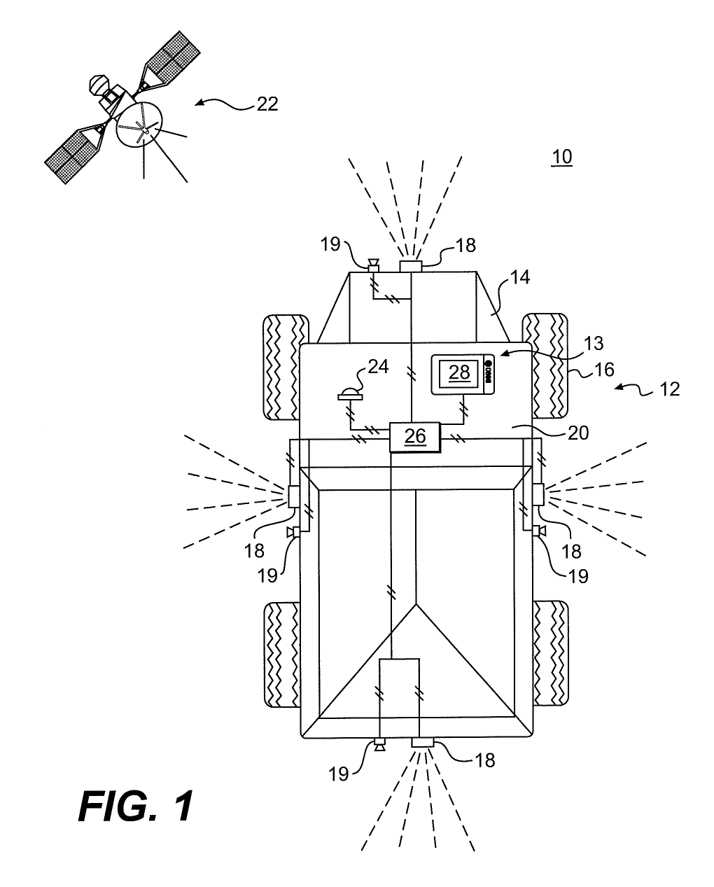

FIG. 1 illustrates an exemplary worksite 10 with a machine 12 performing a predetermined task at worksite 10. Worksite 10 may include, for example, a mine site, a landfill, a quarry, a construction site, a road worksite, or any other type of worksite. The predetermined task may be associated with any work activity appropriate at worksite 10, and may require machine 12 to generally traverse worksite 10. Any number of machines 12 may simultaneously and cooperatively operate at worksite 10, as desired.

Machine 12 may embody any type of machine. For example, machine 12 may embody a mobile machine such as the haul truck depicted in FIG. 1, a service truck, a wheel-loader, a dozer, or another type of mobile machine known in the art. Machine 12 may include, among other things, a body 14 supported by one or more traction devices 16, a plurality of obstacle detection sensors 18 mounted to body 14, and at least one camera 19 mounted to body 14. Obstacle detection sensors 18 and camera(s) 19 may be used for display of the environment around machine 12 from within an operator station 20 of machine 12. As machine 12 travels about worksite 10, a Global Navigation Satellite System (GNSS) 22 or other tracking device or system may communicate with an onboard locating device 24 to monitor the movements of machine 12 and other known objects at worksite 10.

In one embodiment, machine 12 may be equipped with short range sensors 18, medium range sensors 18, and/or long range sensors 18 mounted at different positions around body 14 of machine 12. Each sensor 18 may be a device that detects and ranges objects, for example a LIDAR (light detection and ranging) device, a RADAR (radio detection and ranging) device, a SONAR (sound navigation and ranging) device, a ranging RFID (Radio Frequency Identification) device, or another device known in the art. In one example, each sensor 18 may include an emitter that emits a detection beam to a particular zone within a detection range of worksite 10 around machine 12, and an associated receiver that receives a reflection of that detection beam. Based on characteristics of the reflected beam, a distance and a direction from an actual sensing location of sensor 18 on machine 12 to a portion of the sensed object within the particular zone may be determined. Sensor 18 may then generate a signal corresponding to the distance, direction, size, and/or shape of the object, and communicate the signal to an onboard controller 26 for subsequent conditioning and presentation on a display 28 within operator station 20.

In the disclosed embodiment, work machine 12 may be equipped with multiple cameras 19, the number of cameras 19 being equal to the number of sensors 18. In this configuration, each camera 19 may be able to generate a view associated with a particular zone scanned by a corresponding and paired sensor 18. It is contemplated, however, that fewer cameras 19 than sensors 18 may alternatively be utilized onboard machine 12, if desired, and that one or more of the cameras 19 could be configured to move and generate views associated with more than one zone scanned by multiple sensors 18, if desired. Images of the different views generated by cameras 19 may be communicated to controller 26 for subsequent conditioning and presentation on display 28.

Operator station 20 may house portions of a machine display system 30 that include, among other things, locating device 24, controller 26, and display 28. Display 28 may be positioned proximate an operator seat (not shown) and be configured to show information relating to known and unknown obstacles within the detection range of machine 12, as well as camera images of different zones around machine 12. As will be explained in more detail below, operator station 20 may also include means for receiving input from an operator regarding how the information should be displayed. In one embodiment, display 28, itself, may include hardware and or software that enables the input to be received from the operator of machine 12. In another embodiment, a separate input device (not shown), for example a keyboard, a mouse, a light stick, or another input device known in the art may be included within operator station 20 and communicatively coupled with controller 26 and/or display 28 for receipt of operator input.

One or more locating devices 24 may be associated with machine 12 and other known objects, for example other mobile machines and stationary facilities, at worksite 10. Locating devices 24 may cooperate with the components of GNSS 22 and/or another tracking system (e.g., an Inertial Reference System (IRS), a local tracking system, or another known locating system) to determine a position of machine 12 and positions of the other known objects at worksite 10 and to generate corresponding signals indicative thereof. Locating device 24 may be in communication with controller 26 to convey signals indicative of the received or determined positional information and the identification of the tracked object(s) for further processing. Controller 26, as will be described in more detail below, may then selectively cause a representation of machine 12 and the other known objects to be shown overlaid at their relative positions on an electronic plan view representation of worksite 10 within display 28 of machine 12.

Controller 26 may embody a single microprocessor or multiple microprocessors that include a means for monitoring the location of machine 12 and the other known and unknown objects at worksite 10, and for displaying information regarding characteristics of machine 12 and the objects within operator station 20. For example, controller 26 may include a memory, a secondary storage device, a clock, and a processor, such as a central processing unit or any other means for accomplishing a task consistent with the present disclosure. Numerous commercially available microprocessors can be configured to perform the functions of controller 26. It should be appreciated that controller 26 could readily embody a general machine controller capable of controlling numerous other machine functions. Various other known circuits may be associated with controller 26, including signal-conditioning circuitry, communication circuitry, and other appropriate circuitry. Controller 26 may be further communicatively coupled with an external computer system, instead of or in addition to including a computer system, as desired.

Display 28 may be any appropriate type of device that provides a graphics user interface (GUI) for presentation of machine and object locations and/or other information to operators of machine 12. For example, display 28 may be a computer console or cab-mounted monitor, an LCD screen, a plasma screen, or another similar device that receives instructions from controller 26 and displays corresponding information. It is contemplated that display 28 may also be configured to receive input from the operator regarding desired modes and/or display functionality, for example by way of a touch screen interface or physical buttons and switches, if desired.

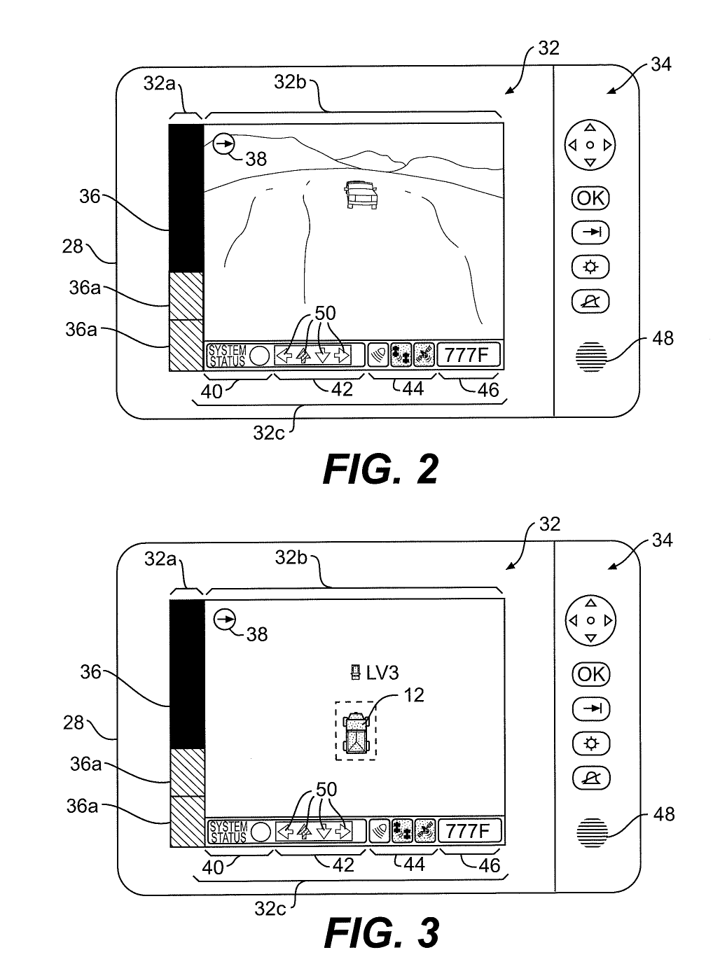

As shown in the particular embodiment of FIG. 2, display 28 may include a screen area 32 and an input area 34. In this embodiment, screen area 32 is divided virtually into a first screen portion 32a associated with display of processed information associated with a proximity of objects relative to machine 12, a second screen portion 32b associated with display of raw information received or determined via obstacle detection sensors 18 and/or cameras 19, and a third screen portion 32c associated with display of status information, sensor information, system information, and machine identification information. It is contemplated that screen area 32 may be divided into as many portions as desired.

First screen portion 32a may be configured to show an indication of machine proximity to detected and tracked objects. In the disclosed embodiment, the indication may be represented by a virtual bar 36 having characteristics that change with the proximity. The characteristics may include, among other things, a size and a color. For example, as machine 12 nears a detected or tracked object (i.e., an object detected via sensors 18 or tracked via GNSS 22), a greater number of segments 36a of virtual bar 36 may become illuminated (i.e., virtual bar 36 may become longer). Additionally, as the proximity becomes less than particular thresholds, a color of virtual bar 36 may change, for example from a green color associated with a farthest range of distances, to a yellow color associated with a closer range of distances, to a red color associated with a closest range of distances. It is contemplated that any number of segments 36a and/or colors may be utilized within virtual bar 36. It is also contemplated that other methods may be utilized to represent the proximity of machine 12 to objects at worksite 10, if desired.

Second screen portion 32b may be configured to selectively show a plan view of worksite 10 (shown in FIG. 2), including a representation of machine 12 in its environment at worksite 10 relative to tracked objects. For example, FIG. 2 shows machine 12 located in a general center of second screen portion 32b and outlined in a box shape, with another known object (e.g., a service truck) shown and identified as LV3 at its respective location relative to machine 12. The other known objects that can be shown on the plan view of display 28 may include any other mobile or stationary machine operating at worksite 10 that is tracked via GNSS 22, with corresponding characteristics such as relative size, shape, type, identification, travel direction, speed, and other parameters represented by related images on second screen portion 32b. In the depicted example, the tracked object shown together with machine 12 is illustrated as having the shape of a service truck, being smaller than machine 12, and being positioned at its true location in front of and traveling toward machine 12. A representation 38 of a travel direction of machine 12 may also be provided in second screen portion 32b (e.g., in the upper left corner of screen portion 32b), overlaid on the plan view of worksite 10. Representation 38 may be associated with a compass travel direction, and include an arrow pointing in the respective direction (i.e., pointed up for North, down for South, left for West, and right for East).

Second screen portion 32b may also be configured to selectively show the views of worksite 10 generated by cameras 19. For example, display 28 in FIG. 3 shows a forward camera view as generated by camera 19 mounted at a forward end of machine 12 (referring to FIG. 1). It is contemplated that second screen portion 32b may be divided into multiple smaller portions, if desired, each of the smaller portions being capable of simultaneously showing a different camera view. An operator may be able to select the number of smaller screen portions, and which camera view should be shown in each portion. In addition, as will be described below, particular camera views may be automatically presented on display 28 based on, among other things, a proximity of detected or tracked objects relative to machine 12 and a travel direction of machine 12.

As mentioned above, third screen portion 32c may be configured to show status information, sensor information, system information, and machine identification information. For this purpose, third screen portion 32c may include a first section 40, a second section 42, a third section 44, and a fourth section 46.

First section 40 may include a status identifier that identifies when display system 30 has an active status, a standby status, and a disabled status. When display system 30 is active, the status identifier may be illuminated in a particular color, for example green, to indicate that display system 30 may be functioning properly and is being controlled to automatically display particular information regarding detected objects. In some embodiments, display system 30 may only be active when machine 12 is stationary (e.g., parked) or traveling in a particular direction (e.g., only forward or only in reverse). When machine 12 travels in a direction other than the particular direction, the status identifier of first section 40 may change colors, for example from green to yellow, to indicate that display system 30 now has a standby status and is being controlled in an alternative manner (e.g., controlled to display tracked information instead of detected information). In some embodiments, machine 12 may need to travel in the direction other than the particular direction for a minimum distance (e.g., about 20 meters) and/or at a speed greater than a first threshold speed (e.g., about 11 km/h) before the status identifier changes from green to yellow. In these embodiments, when machine travel stops for a minimum amount of time or reduces travel speed below a second threshold speed less than the first threshold speed (e.g., about 4.8 km/h), the status identifier may revert back from yellow to green. The disabled status may be illuminated, for example in a red color, to indicate a malfunction of display system 30 has occurred. Specifically, when a fault is detected on one of sensors 18, a communication failure occurs, or when system power deviates from a specified operating range, the system indicator may illuminate in red. In some applications, an audible alarm 48 of display 28 may also sound in response to fault detection.

Second section 42 may include at least one directional indicator 50 associated with a direction in which nearby objects are being detected (e.g., arrows associated with which of sensors 18 is detecting the object). In the disclosed example, second section 42 includes four directional indicators 50, although any number of directional indicators 50 may be utilized, as desired. A first of directional indicators 50 (i.e., the left most arrow shown in FIG. 2) is shown as pointing leftward, and correspond with sensor 18 mounted at a left side of machine 12. The first directional indicator 50 may illuminate when the left-located sensor 18 detects an object to the left of machine 12. A second of directional indicators 50 (i.e., the arrow located just the right of the first arrow) may point toward a top portion of display 28 and correspond with sensor 18 mounted at a front end of machine 12. The second directional indicator 50 may illuminate when the front-located sensor 18 detects an object in front of machine 12. A third of directional indicators 50 (i.e., the arrow located just the right of the second arrow) may point toward a bottom portion of display 28 and correspond with sensor 18 mounted at a rear end of machine 12. The third directional indicator 50 may illuminate when the rear-located sensor 18 detects an object behind machine 12. A fourth of directional indicators 50 (i.e., the arrow located just to the right of third arrow) may point rightwards, and correspond with sensor 18 mounted at a right side of machine 12. The fourth directional indicator may illuminate when the right-located sensor 18 detects an object to the right of machine 12.

Directional indicators 50 may be selectively shown on display 28 in different ways to relay different information. For example, the second directional indicator 50 from the left shown in FIG. 2 is illustrated in a different color (represented by hatch marks), as compared to the remaining directional indicators 50. The color of the second directional indicator 50 may correspond with a detection direction of an object determined to be closest to machine 12 (i.e., the objects detected in the directions corresponding with the remaining three directional indicators 50 may be further away than the object detected in the direction of the second directional indicator 50). In one embodiment, the color of directional indicator 50 corresponding to the closest detected object may be the same general color used in segments 36a of virtual bar 36, to thereby correlate the proximity of the closest object to the detection direction of that object. In other words, when more than one object is simultaneously detected by sensors 18, a proximity to only one of those objects (i.e., the closest object) may be represented by virtual bar 36. At the same time that the proximity of the closest object is represented by virtual bar 36, a direction of that closest object may be shown with one of directional indicators 50 by changing the color of that directional indicator 50 to match the color of segments 36a.

One or more of directional indicators 50 may also be shown differently on display 28 according to the particular camera view(s) displayed within second screen portion 32b. In particular, the directional indicator(s) 50 corresponding with the direction of the camera view(s) currently being displayed may be shown with a box around them. In the examples of FIGS. 2 and 3, the second directional indicator 50 from the left is shown with a box around it, as the image being displayed in second screen portion 32b corresponds with a direction in front of machine 12. It should be noted that two different directional indicators 50 may simultaneously have a color different from the remaining directional indicators and be shown within the box, if desired, such as when an operator selects a camera view for display that does not correspond with a detection direction of the closest object.

Third section 44 may provide information regarding a status of detection sensors 18 and GNSS 22. Specifically, third section 44 may include a first status identifier 52 associated with detection sensors 18, and a second status identifier 54 associated with GNSS 22. In one example, first status identifier 52 may resemble a physical embodiment of detection sensors 18, while second status identifier 54 may resemble a satellite. Based on a status of these devices/systems, the individual status identifiers 52, 54 may be shown differently, for example in different colors. In the disclosed embodiment, status identifiers 52, 54 may be illustrated in green (functional and active), yellow (functional but in standby), and red (non-functional) colors. It is contemplated that status identifiers 52, 54 may be shown differently and/or that the different ways of showing status identifiers 52, 54 on display 28 may correspond with different meanings, if desired.

In addition to status identifiers 52, 54, third section 44 may also include an information identifier 56 that identifies the source of proximity information utilized to display virtual bar 36. In particular, it may be possible in some situations for the proximity information used to display virtual bar 36 to be provided by GNSS 22 rather than detection sensors 18. This may occur, for example, when machine 12 is moving at a speed high enough to make information from sensors 18 inaccurate and/or unreliable (e.g., higher than the threshold speed that causes the standby status to be displayed within first section 40). In these situations, virtual bar 36 may be generated based on information from only GNSS 22, and information identifier 56 may be illuminated at this time to make an operator aware of the source of information.

Fourth section 46 may provide identification information regarding machine 12 to the operator of machine 12. For example, fourth section 46 of FIGS. 2 and 3 is shown as displaying “777F” indicating that machine 12 is a Caterpillar off-highway truck having a model number of 777F. The information provided within fourth section 46 may be provided by the owner/operator of machine 12 and/or detected automatically by controller 26 during startup of machine 12.

Input area 34 may allow the operator of machine 12 to provide instructions regarding display preferences. Specifically, input area 34 may allow the operator to direct how many sections should be provided within second screen portion 32b and what information should be displayed within each section. For example, the operator may choose to display information obtained via GNSS 22/locating device 24 (e.g., the plan view of worksite 10), to display information obtained via cameras 19 (e.g., the camera views), or other information known in the art. Input area 23 may also provide a way for canceling and/or silencing different alerts and/or alarms.

Controller 26 may be configured to receive signals from sensors 18, cameras 19, GNSS 22, locating device 24, and/or other sources, and cause related information to be shown on display 28 in the manners described above. For example, controller 26 may be configured to receive signals from each of the different sensors 18 and make a determination, based on the signals, if any objects are in the vicinity of machine 12 and which of those objects are closest to machine 12. Based on this determination, controller 26 may cause particular segments 36a of virtual bar 36 to illuminate a particular color, cause corresponding directional indicators 50 to illuminate, and selectively change the color of one of directional indicators 50 to match the color of virtual bar 36. In addition, controller 26 may selectively cause information identifier 56 to illuminate based on the source of information used to generate virtual bar 36.

In one embodiment, controller 26 may automatically cause different camera views to be shown within second portion 32b of display 28 based on the proximity of detected or tracked objects at worksite 10. For example, controller 26 may determine the location of the object closest to machine 12 (detected or tracked) and, based on this determination, cause a corresponding camera view to be automatically shown on display 28. When multiple objects of about the same proximity are detected at worksite 10 around machine 12, controller 26 may be configured to toggle between multiple camera views corresponding with a detection direction of those objects. It is also contemplated that an operator of machine 12 may manually toggle between the different camera views, if desired, by way of input area 34.

Controller 26 may be configured to show selective information on display 28 depending on a travel direction of machine 12. For example, when machine 12 is traveling in a reverse direction, controller 26 may inhibit camera views from automatically being displayed and/or changed (i.e., controller 26 may automatically cause different camera views to be shown only when machine 12 is stopped or traveling in a forward direction). In another example, a rear-facing camera view may be caused to automatically display when machine 12 begins travel in the reverse direction and, when no objects are detected near machine 12 during forward travel, the plan view may be caused to automatically display.

Controller 26 may also be configured to selectively inhibit display of virtual bar 36 based on information from sensors 18 under certain circumstances. For example, when machine 12 has traveled in a forward direction for about 20 meters or more and/or is traveling at a speed greater than about 11 km/h, controller 26 may cause virtual bar 36 to be displayed based on only information obtained via GNSS 22/locating device 24. At this same point in time, controller 26 may also cause first section 40 to indicate that display system 30 has entered the standby mode. It is contemplated that the owner/operator of machine 12 may be able to select whether the distance threshold, the speed threshold, or both thresholds are considered by controller 26 when determining how to control display system 30, if desired. During forward travel over greater distances and/or at higher speeds, as described above, virtual bar 36 may be displayed based on information from only GNSS 22, while at the same time, information indicator 56 may be illuminated to alert the operator as to the source of the proximity information.

As described above, controller 26 may cause alarm 48 to sound when detected and/or tracked objects are within a threshold distance of machine 12. Alarm 48 may be silenced by the operator of machine 12 in at least two different ways. For example, alarm 48 may be cancelled when an operator of machine 12 presses a corresponding button (e.g., a cancellation button) of input area 34. In one embodiment, however, even when the corresponding button is depressed, alarm 48 may continue to sound until after a transmission (not shown) of machine 12 is moved out of a travel gear. That is, alarm 48 may be reset only by first putting machine 12 into a parked or neutral transmission setting. In another example, alarm 48 may be temporarily silenced via manipulation of a corresponding button of input area 34 (e.g., an alarm snooze button), regardless of the transmission setting. Alarm 48 may be temporarily silenced until a gear selection of the transmission changes, a travel direction of machine 12 changes, and/or a tool of machine 12 is controllably moved, at which time alarm 48 may be caused by controller 26 to resume sounding.

### INDUSTRIAL APPLICABILITY

The disclosed machine display system finds potential application within any mobile machine at any worksite where it is desirable to display within the machine an electronic representation of the machine's surrounding environment at the worksite. The disclosed machine display system may be capable of simultaneously displaying object detection proximity information and corresponding camera views. By allowing the simultaneous display of this overlapping information, an operator of the associated machine may be able to correlate the information obtained from different sources and make decisions that are more informed. In addition, the disclosed machine display system may be capable of automatically correlating the information and utilizing information from one source as input to the other source for enhanced obstacle detection and tracking.

It will be apparent to those skilled in the art that various modifications and variations can be made to the machine display system of the present disclosure. Other embodiments will be apparent to those skilled in the art from consideration of the specification and practice of the machine display system disclosed herein. It is intended that the specification and examples be considered as exemplary only, with a true scope being indicated by the following claims and their equivalents.

What is claimed is:

1. A display system for a mobile machine operating at a worksite, comprising:
at least one detection device mounted on the mobile machine and configured to detect objects within a distance of the mobile machine;
at least one camera mounted on the mobile machine and configured to generate a plurality of camera views of the worksite around the mobile machine;
a display located within the mobile machine; and
a controller in communication with the at least one detection device, the at least one camera, and the display, the controller being configured to:
cause an indication of proximity of objects to be shown on the display based on information from the at least one detection device; and
automatically cause the camera view of the plurality of camera views associated with a closest objected detected by the at least one detection device to be shown on the display simultaneous with the indication of proximity.

2. The display system of claim 1, wherein the indication of proximity includes a virtual bar having a characteristic corresponding to the proximity of objects detected by the at least one detection device.

3. The display system of claim 2, wherein the characteristic includes at least one of a size and a color corresponding to the proximity of objects detected by the at least one detection device.

4. The display system of claim 2, wherein the indication of proximity also includes at least one directional indicator showing a direction of objects detected by the at least one detection device relative to the mobile machine.

5. The display system of claim 4, wherein:
the at least one detection device includes a plurality of detection devices;
the at least one directional indicator includes a plurality of arrows corresponding to a number of the plurality of detection devices; and
the arrow of the plurality of arrows corresponding with the detection device of the plurality of detection devices that is detecting the object closest to the mobile machine is shown differently then a remainder of the plurality of arrows.

6. The display system of claim 5, wherein:
the number of the plurality of camera views corresponds with the number of the plurality of detecting devices;
the camera view of the plurality of camera views shown on the display is user selectable; and
the arrow of the plurality of arrows corresponding with the camera view of the plurality of camera views shown on the display is shown differently than a remainder of the plurality of arrows.

7. The display system of claim 1, wherein the detection device is one of a RADAR device, a LIDAR device, or a SONAR device.

8. The display system of claim 1, wherein the at least one camera includes a plurality of different cameras, each configured to provide a camera view corresponding with a different zone around the mobile machine.

9. The display system of claim 8, wherein if multiple objects of similar proximity are simultaneously detected by the at least on detection device, the controller is further configured to selectively toggle between different camera views corresponding with locations of the multiple objects within the different zones.

10. The display system of claim 1, wherein the controller is configured to automatically cause the camera view associated with the closest objected to be shown on the display only when the mobile machine is stopped or moving in a forward direction.

11. The display system of claim 1, further including a locating system configured to track objects at the worksite, wherein the controller is further configured to cause a plan view of positions of tracked objects relative to a location of the mobile machine to be shown on the display.

12. The display system of claim 11, wherein the controller is further configured to receive operator input indicative of a desire to show the camera view or the plan view, and selectively show the camera view or the plan view based on the operator input.

13. The display system of claim 12, wherein the controller is configured to selectively show the camera view or the plan view based also on a travel direction of the mobile machine.

14. The display system of claim 11, wherein, when the mobile machine has traveled for a distance greater than a threshold distance in a forward direction or is traveling at a speed greater than a threshold speed in the forward direction, the controller is configured to stop causing the indication of proximity of objects to be shown on the display based on information from the at least one detection device and to start causing the indication of proximity of objects to be shown on the display based on information from the locating system.

15. The display system of claim 14, wherein the controller is further configured to also show on the display an indication of a source of information used to display the indication of proximity.

16. The display system of claim 1, wherein the controller is further configured to activate an alarm associated with the display when a proximity of a detected object becomes less than a threshold distance.

17. The display system of claim 16, wherein the display includes an alarm cancellation button, and the controller is configured to cancel the alarm based on manipulation of the alarm cancellation button only after a transmission of the mobile machine has been moved out of a travel gear.

18. The display system of claim 17, wherein the display includes an alarm snooze button, and the controller is configured to temporarily silence the alarm based on manipulation of the alarm snooze button until a gear selection of the transmission changes, a travel direction of the mobile machine changes, or a tool of the mobile machine is controllably moved.

19. The display system of claim 1, wherein the display includes a status indicator.

20. A display system for a mobile machine operating at a worksite, comprising:
a plurality of detection devices mounted on the mobile machine and configured to detect objects within different zones around the mobile machine;
a display located within the mobile machine; and
a controller in communication with the at least one detection device and the display, the controller being configured to:
cause an indication of proximity of objects detected by the plurality of detection devices to be shown on the display; and
cause a plurality of directional indicators to be shown on the display, each of the plurality of directional indicators corresponding with a different zone in which an object is detected,
wherein the directional indicator of the plurality of directional indicators corresponding with the zone having the detected object located closest to the mobile machine is shown differently on the display than a remainder of the plurality of directional indicators.

21. The display system of claim 20, wherein the indication of proximity includes a virtual bar having a characteristic corresponding to the proximity of objects detected by the plurality of detection devices.

22. The display system of claim 21, wherein the characteristic includes at least one of a size and a color corresponding to the proximity of objects detected by the plurality of detection devices.

23. The display system of claim 20, further including at least one camera mounted on the mobile machine and configured to generate a plurality of camera views of the worksite around the mobile machine, wherein:
the controller is configured to cause the plurality of camera views to be shown on the display, the number of the plurality of camera views corresponding with the number of the plurality of detecting devices;
the camera view of the plurality of camera views shown on the display is user selectable; and
the directional indicator of the plurality of directional indicators corresponding with the camera view of the plurality of camera views shown on the display is shown differently than a remainder of the plurality of directional indicators.

24. The display system of claim 23, further including a locating system configured to track objects at the worksite, wherein the controller is further configured to cause a plan view of positions of tracked objects relative to a location of the mobile machine to be shown on the display.

25. The display system of claim 24, wherein the controller is further configured to:
receive operator input indicative of a desire to show the camera view or the plan view; and
selectively show the camera view or the plan view based on the operator input.

26. The display system of claim 25, wherein the controller is configured to selectively show the camera view or the plan view based also on a travel direction of the mobile machine.

27. The display system of claim 24, wherein the controller is further configured to selectively cause the indication of proximity of objects to be shown on the display based on information provided by the locating system.

28. The display system of claim 27, wherein the controller is further configured to also show on the display an indication of a source of information used to determine the proximity.

29. The display system of claim 20, wherein each of the plurality of detection devices is one of a RADAR device, a LIDAR device, or a SONAR device.

30. The display system of claim 20, wherein the controller is further configured to activate an alarm in the display when a proximity of a detected object becomes less than a threshold distance.

31. The display system of claim 30, wherein the display includes an alarm cancellation button, and the controller is configured to cancel the alarm based on manipulation of the alarm cancellation button only after a transmission of the mobile machine has been moved out of a travel gear.

32. The display system of claim 31, wherein the display includes an alarm snooze button, and the controller is configured to temporarily silence the alarm based on manipulation of the alarm snooze button until a gear selection of the transmission changes, a travel direction of the mobile machine changes, or a tool of the mobile machine is controllably moved.

33. The display system of claim 20, wherein the display includes a status indicator.

34. A display system for a mobile machine operating at a worksite, comprising:
a plurality of detection devices mounted on the mobile machine and configured to detect objects within different zones around the mobile machine;
at least one camera mounted on the mobile machine and configured to generate a plurality of camera views of the worksite around the mobile machine;
a locating system configured to track objects at the worksite;
a display located within the mobile machine; and
a controller in communication with the plurality of detection devices, the at least one camera, the locating system, and the display, the controller being configured to:
cause a virtual bar to be shown on the display based on information from either the at least one detection device or the locating system, the virtual bar having at least one of a size and a color corresponding to a proximity of objects relative to the mobile machine;
cause an indication of a source of information used to determine the proximity to be shown on the display;
automatically cause a camera view of the plurality of camera views associated with a closest objected detected or tracked within the proximity of the mobile machine to be shown on the display simultaneous with the virtual bar; and
cause a plurality of arrows to be shown on the display, each of the plurality of arrows corresponding with a different zone in which an object is detected,
wherein:
the arrow of the plurality of arrows corresponding with the zone having the detected or tracked object located closest to the mobile machine is shown differently on the display than a remainder of the plurality of arrows; and
the arrow of the plurality of arrows corresponding with the camera view of the plurality of camera views shown on the display is shown differently than a remainder of the plurality of arrows.
